(19) United States
(12) Patent Application Publication
(10) Pub. No.: US 2008/0294625 A1
(43) Pub. Date: Nov. 27, 2008

(54) Item recommendation system

(75) Inventor: Masaru Takeuchi, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/068,702

(22) Filed: Feb. 11, 2008

(30) Foreign Application Priority Data
May 23, 2007 (JP) 2007-137045

(51) Int. Cl. G06F 17/30

(52) U.S. Cl. 707/5; 707/E17.014

(57) ABSTRACT

To recommend an item which is highly unexpected to a user because its similarity to user preferences is low and which is useful to the user. A rule that modifies a set of keywords for recommending an item is randomly applied, and a keyword which a user does not prefer is added and a keyword which a user prefers is removed, and then this recommendation result is mixed with a recommendation result of a set of keywords before the above modification, and the mixed result is presented to a user and at the same time the application probability of a rule is learned on the basis of the user's evaluation to a recommended item.

### CLAIM OF PRIORITY

The present application claims priority from Japanese application JP 2007-137045 filed on May 23, 2007, the content of which is hereby incorporated by reference into this application.

### BACKGROUND OF THE INVENTION

1. Field of the Invention

The present invention relates to a recommendation technique in the field of artificial intelligence for prompting a user to purchase a product or to view a program.

2. Description of the Related Art

There are two methods for recommending items, such as products, and programs. One is a method for recommending similar items. In this method, similar items are recommended to a user using a set of keywords characterizing the items. This is generally referred to as a content based item recommendation method (Contents-Based Recommendation). The other is a method for recommending dissimilar items. In this method, a set of keywords are not used, but items which are not necessarily similar to each other are recommended to a user. The typical approaches therefor include the one called Collaboration Filtering. In this method, items are recommended using the selection tendencies of persons whose selection tendencies of items are similar to those of a target user receiving a recommendation.

With the content based item recommendation method, an unexpected item may not be recommended since similar items are recommended. Japanese Patent Application Laid-Open Publication No. 2001-265808 and Workshop Document SIG-KBS-9904, Japanese Society for Artificial Intelligence relate to techniques for finding out a book having both usefulness and unexpectedness, so as to recommend the book to a customer.

### SUMMARY OF THE INVENTION

In the above-described prior arts, a customer profile is generated as follows: that is, for each category, a set of keywords of books which a customer purchased in the past are combined together; on the other hand, a set of keywords is generated for each book on a basis of a book database; then, a similarity between a set of keywords for a customer profile and a set of keywords for each unpurchased book is calculated particularly with a combination of different categories to thereby search for a book from the viewpoints of both usefulness and unexpectedness. However, when a set of keywords for a certain category is used as a set of keywords for another category in the content based recommendation system, an unpurchased book with high similarity can be recommended but an unpurchased book with low similarity cannot be recommended.

It is thus an object of the present invention to recommend an item, which is highly unexpected to a user, with high efficiencies. Here, an item refers to a product, a book, a Web page, or a TV program. Moreover, the phrase “highly unexpected” means that the similarity between a set of keywords expressing user preferences and a set of keywords expressing the features of an item is low. Further, the phrase “with high efficiencies” means that a user frequently selects a recommended item through actions, such as product purchasing, Web browsing, and TV viewing, or means that a user frequently gives high marks (rating) thereto.

According to an aspect of the present invention, in a content based item recommendation method for retrieving an item using a set of user preference keywords expressing user preferences as a set of recommending keywords, provided are a function to randomly add, to the set of recommending keywords, a keyword which a user does not prefers, and a function to randomly remove a part of preference keywords from the set of recommending keywords. This random modification, i.e., addition or deletion of a keyword, is executed using a modification rule (which is also referred to as change rule). In the modification rule, a keyword, user profile, genre, and the like contained in a recommending keyword are described in a condition unit indicative of an applicable condition, while a keyword deleted from and a keyword added to the set of recommending keywords are described in an action unit indicative of a modification content to the set of recommending keywords. Further, a weight indicative of the frequency to which a rule is applied is given to a modification rule. When a user selects a recommended item or a user gives a high mark (rating) thereto, the weight of a modification rule that was used for retrieving the relevant item will increase, or otherwise the weight will decrease. The set of modification rules is shared among all users, and the recommendation function and the evaluation function are executed randomly and repeatedly.

### BRIEF DESCRIPTION OF THE DRAWINGS

FIG. 1 is an explanatory view of the overall configuration of an unexpected-item recommendation system.

FIG. 2 is the whole processing processes of an unexpected-item recommendation method.

FIG. 3 is an explanatory view of the data configuration of a client DB.

FIG. 4 is an explanatory view of the data configuration of a keyword record DB.

FIG. 5 is an explanatory view of the data configuration of a content DB.

FIG. 6 is an explanatory view of the data configuration of a keyword DB.

FIG. 7 is an explanatory view of the data configuration of a recommendation temporary record DB.

FIG. 8 is an explanatory view of the data configuration of a modification rule DB.

FIG. 9 is an explanatory view of a preference keyword extraction function.

FIG. 10 is a PAD diagram showing the processing processes of a text information extraction function in a preference keyword extraction process.

FIG. 11 is a PAD diagram showing the processing processes of a keyword record DB update function in the preference keyword extraction process.

FIG. 12 is a PAD diagram showing the processing processes of a client DB update function in the preference keyword extraction process.

FIG. 13 is an explanatory view of a mixing recommendation function.

FIG. 14 is a PAD diagram showing the processing processes of content based recommendation.

FIG. 15 is PAD diagram showing the processing processes of random modification recommendation.

FIG. 16 is a PAD diagram showing the processing processes of keyword adding recommendation.

FIG. 17 is an explanatory view of an evaluation feedback function.

FIG. 18 is a PAD diagram showing the processing processes of evaluation feedback processing.

FIG. 19 is an explanatory view of a modification rule base construction support interface.

FIG. 20 is an explanatory view of a client interface.

FIG. 21 is an explanatory view of a client side configuration of the unexpected-item recommendation system.

FIG. 22 is an explanatory view of a server side configuration of the unexpected-item recommendation system.

FIG. 23 is an explanatory view of a modification rule base learning process.

### DESCRIPTION OF THE PREFERRED EMBODIMENTS

By randomly adding/deleting an item to/from a set of recommending keywords, an item which a user may find unexpected can be recommended. However, when a keyword is randomly deleted or added, the recommendation efficiency is low. Accordingly, a modification rule is used, which adds or deletes a keyword described in the action unit corresponding to the keyword, user profile, genre, etc. contained in a recommending keyword described in the condition unit. A weight given to the modification rule will increase when a user selects an item that was recommended using the modification rule or when a user gives a high mark (rating) thereto. For this reason, the likelihood that the modification rule is applied next will increase, while the likelihood that the modification rule without an increased weight is applied next will decrease. The modification rule that contributed to generation of an item which a certain user selected is most likely to be used in item recommendation to other users with similar profiles, due to the sharing of a set of the modification rules by users. Consequently, the validity of the modification rule will be presented to other users, thereby enabling to generate a set of the modification rules for making highly efficient recommendation for all users.

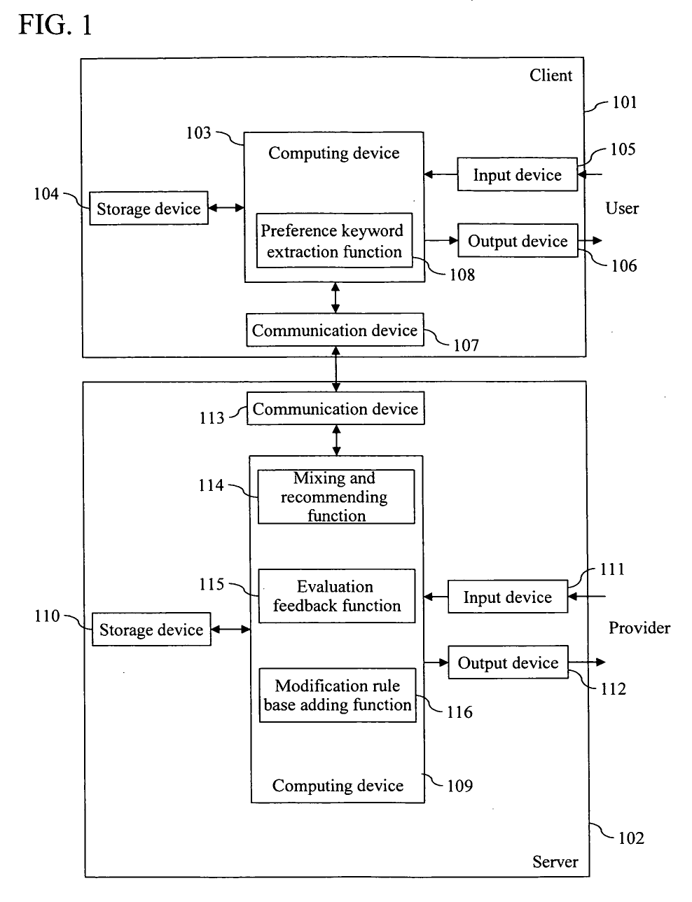

FIG. 1 shows the overall configuration of an item recommendation system of the present invention. The system of this embodiment extracts keywords, which a user prefers, from a history of the user's Web browsing and TV viewing and manages the same, and recommends an item (TV program or the like) to the user on the basis of these preference keywords. The item recommendation system of the present invention includes a client 101 and a server 102. The client includes a computing device 103, a storage device 104, an input device 105, an output device 106, and a communication device 107, and primarily performs a preference keyword extraction function 108. As with the client, the server also includes a computing device 109, a storage device 110, an input device 111, an output device 112, and a communication device 113, and primarily performs a mixing recommendation function 114, an evaluation feedback function 115, and a modification rule base update function 116.

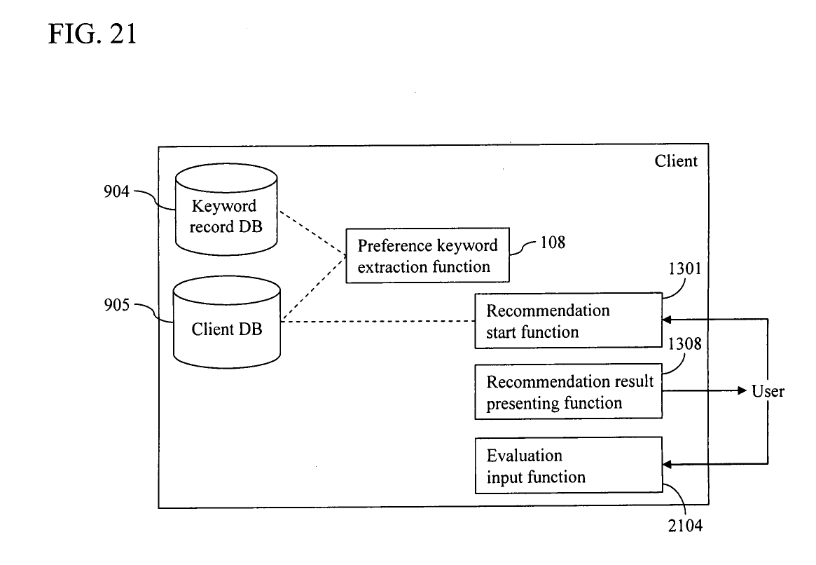

FIG. 21 shows the configuration of client side functions and DBs (database). The client includes: the preference keyword extraction function 108 that extracts user's preference keywords from Web browsing and TV viewing; a recommendation start function 1301 with which a user causes the system to recommend an item; a recommendation result presenting function 1308 to display a recommendation result; an evaluation input function 2104 to input a user's evaluation with respect to a recommended item; a keyword record DB 904 that temporarily records keywords about the user's Web browsing, TV viewing; and a client DB 905 that records the profile and preference keywords of the client. Note that with respect to each DB in FIG. 21, read and write of data are performed by the functional modules coupled by broken lines. Moreover, the arrow indicates data passing relation between the functional modules, or between the functional module and the outside world.

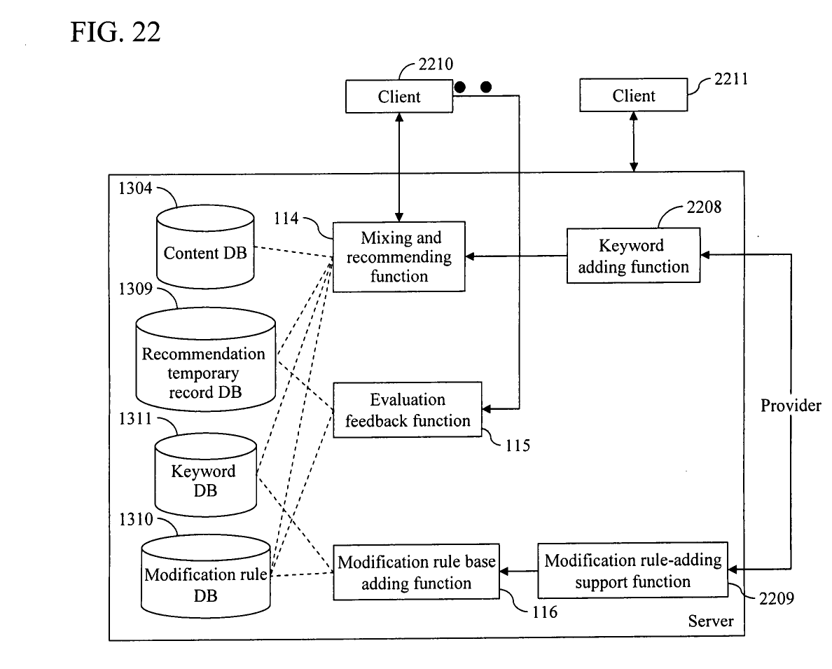

FIG. 22 shows the configuration of server side functions and DBs. The server includes: the mixing recommendation function 114 in which an unexpected-item recommendation method of the present invention is implemented, the evaluation feedback function 115 to reflect a user's evaluation result on a recommendation method of the mixing recommendation function; the modification rule base adding function 116 to initialize a later-described modification rule DB 1310 and add a rule; a content DB 1304 that records a relation between an item and a keyword; a recommendation temporary record DB 1309 that record a relation between a keyword used in recommendation and an item to be recommended; a keyword DB 1311 that records all the keywords about Web pages or TV programs which multiple users accessed; a keyword adding function 2208, and a modification rule adding support function 2209. Note that multiple clients 2210, 2211 are connected to the server.

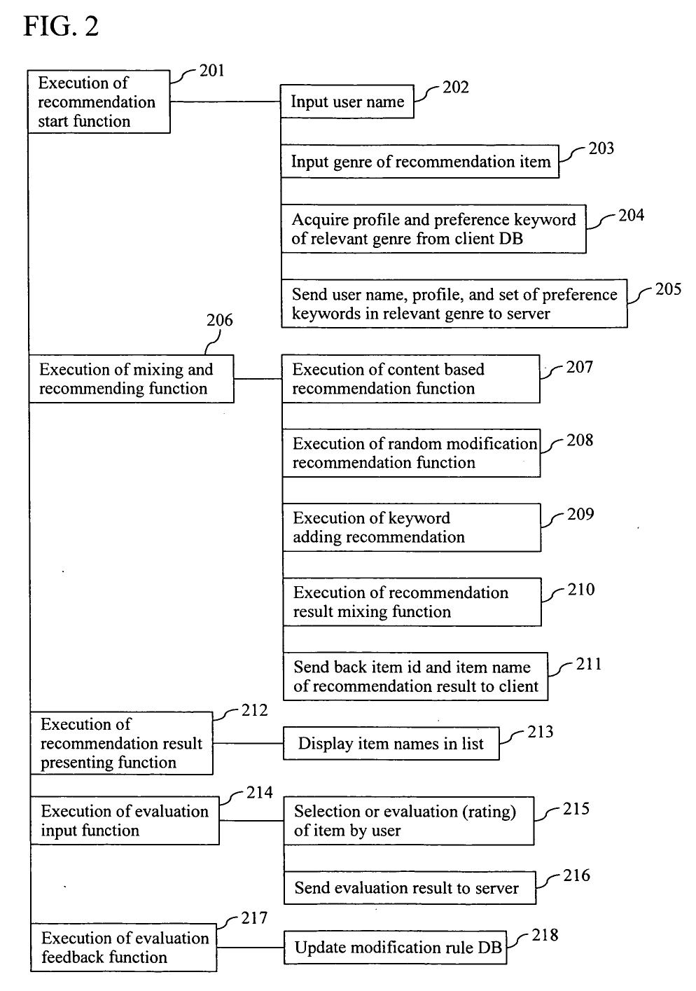

FIG. 2 shows the whole processing processes of the unexpected-item recommendation method according to the present invention. When the recommendation start function in the client is executed 201, the mixing and recommending function is executed by the server 206 and the recommendation result presenting function is executed by the client 212. With respect to the recommendation result, when the evaluation input function is executed, by which a user selects a recommended item or a user provides evaluation (rating) to the recommended item 214, the evaluation feedback function is executed by the server 217.

In the execution of the recommendation start function 201, a user name is inputted 202 and the genre of a recommendation item is inputted 203, and the profile and the preference keywords in the genre are acquired from the client DB 204, and then a user name, the profile, and the preference keywords in the genre are sent to the server 205.

In the execution of the mixing and recommending function 206, three recommendation functions described below are executed. These functions are a content based recommendation function 207, which is a prior art, a random modification and recommendation function 208 that plays an essential role in the present invention, and a keyword adding and recommending function 209 by which a provider adds current news terms, terms related to a sponsor, and the like. These recommendation results are mixed with a predetermined ratio in the execution of a recommendation result mixing function 210, and an item ID and item name as the recommendation result are sent back to the client 211.

In the execution of the recommendation result presenting function 212, a list of item names is displayed for the user 213. In the execution of the evaluation input function 214, an evaluation result of the selection or evaluation (rating) of an item by the user 215 is sent to the server 216, and on the basis of this, the evaluation feedback function is executed 217 and the modification rule DB is updated 218.

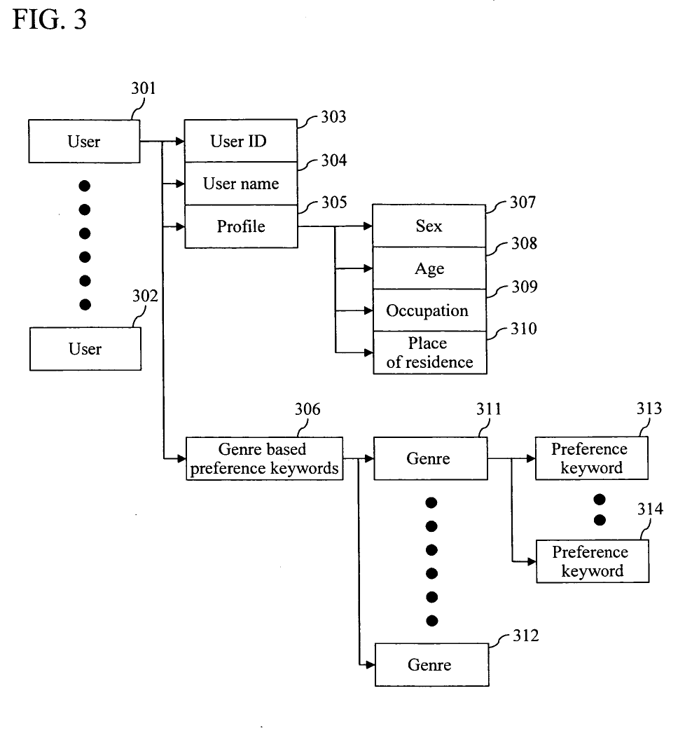

FIG. 3 shows a data configuration of the client DB. The client DB records information about multiple users 301, 302. The content thereof includes a user ID 303 for identifying a user, a user name 304 and profile 305 which a user registers, and a genre-based preference keyword 306 which the system uses for recommendation. In this embodiment, sex 307, age 308, occupation 309, and place of residence 310 are used as the profile 305. Moreover, multiple genres 311, 312 and preference keywords 313, 314 which a user prefers in the relevant genre are recorded in the genre-based preference keyword. Here, types of items (TV programs), which a provider defined, for example, phrases such as, news, sports, cooking, traveling and trying the food at various restaurants, and actions are put in a genre.

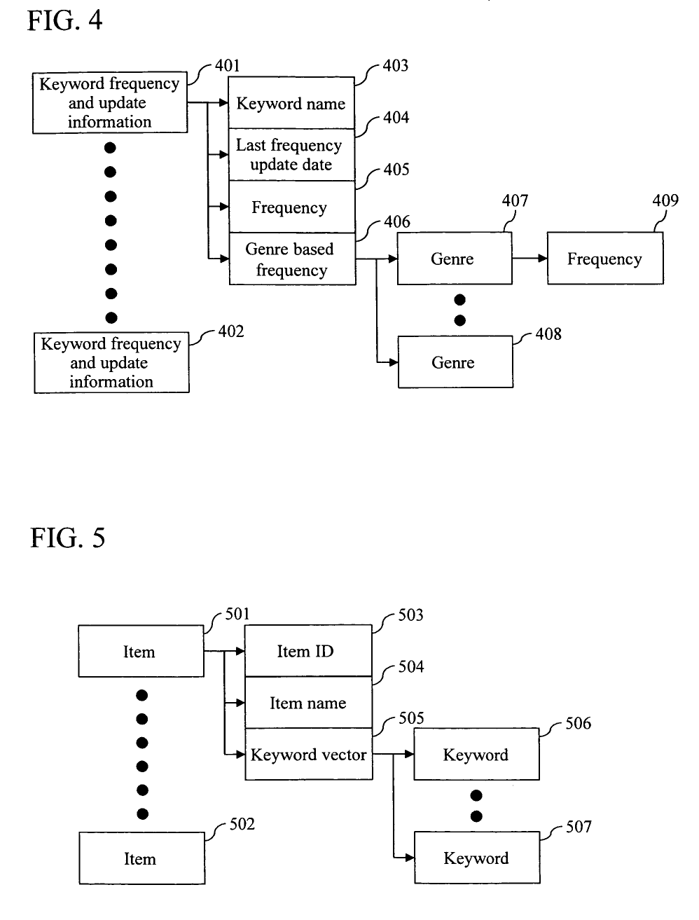

FIG. 4 shows a data configuration of the keyword record DB. The keyword record DB records information about the frequency and update time of a keyword from the texts about each user's Web browsing and TV viewing. These keyword frequency and update information 401, 402 include a keyword name 403, last frequency update date 404, a total frequency 405 and genre-based frequency 406 that appeared in the above-described texts. Note that genres 407, 408 take a value in accordance with the client DB of FIG. 3.

FIG. 5 shows a data configuration of the content DB. The content DB is data for retrieving items (TV programs) 501, 502, and includes an item ID 503, an item name 504, and a set of keywords (keyword vector) 505 indicative of the content thereof. Keywords 506, 507 characterizing an item acquired from an EPG or an Internet TV Guide are recorded in the set of keywords.

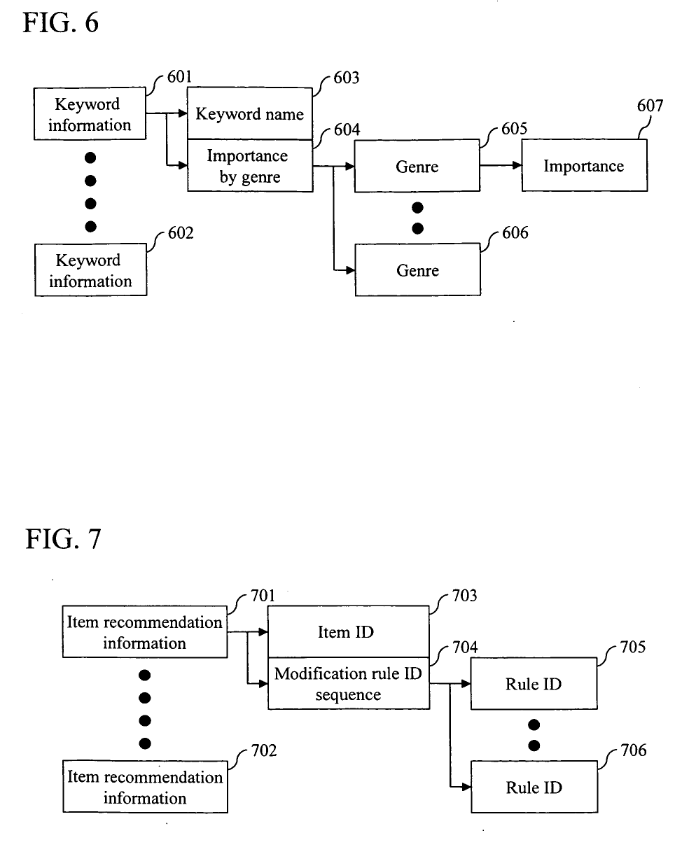

FIG. 6 shows a data configuration of the keyword DB. With respect to the set of keywords of all the items which the content DB shown in FIG. 5 retains, a keyword name 603 and its importance by genre 604 are recorded as keyword information 601, 602 in the keyword DB. The importance by genre includes genres 605, 606 and importance 607. Here, as for the importance by genre, a ratio of the frequency of appearance of a keyword in the relevant genre to the total frequency of appearance is recorded.

FIG. 7 shows a data configuration of the recommendation temporary record DB. For the recommendation temporary record DB, a correspondence between an item to be recommended and a later-described rule for changing a set of keywords that is used in retrieval of the item is recorded as item recommendation information 701, 702. The item recommendation information includes a recommended item ID 703 and a modification rule ID sequence 704, and the modification rule ID sequence includes multiple rule IDs 705, 706.

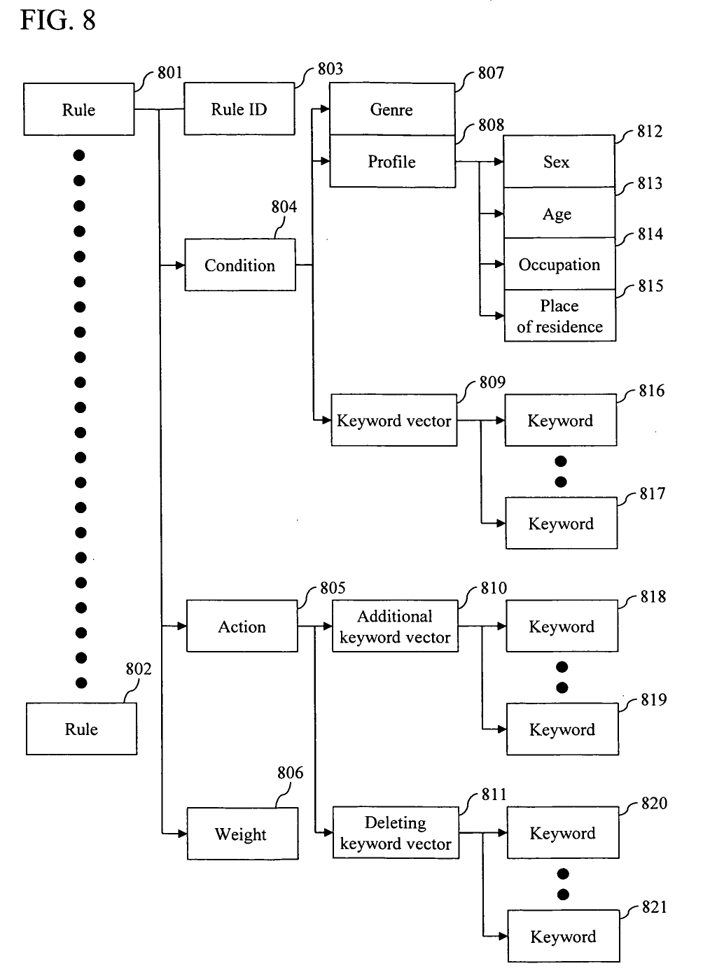

FIG. 8 shows a data configuration of the modification rule DB. The modification rule DB includes multiple rules 801, 802. Each rule includes a rule ID 803, a condition 804 indicative of an applicable condition of a rule, an action 805 that is executed when the applicable condition is satisfied, and a weight 806 indicative of to what degree the rule is applied. The condition includes a genre 807, a profile 808, and a set of keywords (keyword vector) 809, in which sex 812, age 813, occupation 814, and place of residence 815 are used as the profile, as in the case of the client DB shown in FIG. 3. Moreover, the action includes a set of additional keywords (keyword vector) 810 and a set of deleting keywords (keyword vector) 811. The respective vectors include a set of keywords 816 to 821.

Examples of the update rule include the following.

Rule 1: If Genre (“drama”) and HasKeyword (“hot spring”) then AddKeyword “detective”

Rule 2: If HasKeyword (“fishing”) and HasKeyword (“trout”) then DeleteKeyword (“trout”)

Rule 3: If Genre (“news”) and UserAge (“40 years of age and older”) then AddKeyword (“metabolic syndrome”)

Rule 1 is an update rule, in which when “hot spring” is contained in the set of keywords 809 which a user prefers and when a recommendation is made in the genre called “drama” 807, a keyword “detective” stored in the additional keyword 810 is added. Rule 2 is a deletion rule, in which when “fishing” and “trout” are contained in the set of keywords 809 which a user prefers and when a recommendation is made, a keyword “trout” stored in the deleting keyword 811 is deleted. Rule 3 is an update rule, in which when the age 813 in the user profile 808 is “40 years of age and older” and when a recommendation is made in the genre 807 called “news”, a keyword “metabolic syndrome” stored in the additional keyword 810 is added.

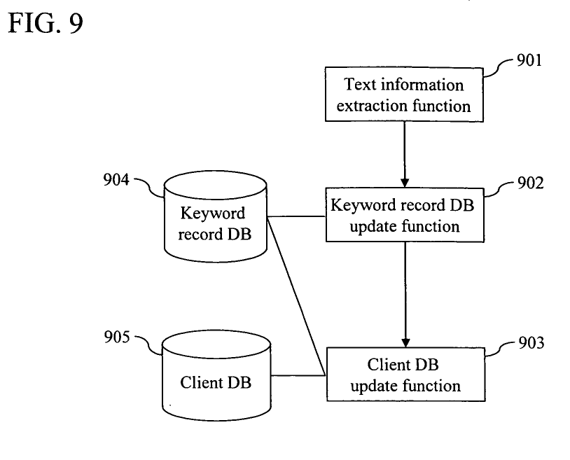

The preference keyword extraction function is described using FIG. 9 to FIG. 12. In the present invention, user preferences are recorded as a set of keywords, which is then used for recommendation. This set of keywords is referred to as a set of user preference keywords. The set of user preference keywords is a group of keywords that frequently appear in Web pages which a user viewed, and in an EPG (electronic program guide) or a TV Guide over the Internet of TV programs which the user viewed.

FIG. 9 shows a configuration of the preference keyword extraction function. The preference keyword extraction function includes: a text information extraction function 901 that extracts a keyword from the user's Web browsing contents and TV viewing contents, a keyword record DB update function 902 that records and updates the frequency of an extracted keyword into the keyword record DB 904, and a client DB update function 903 that analyzes the content of the keyword record DB to prepare a set of user preference keywords in the client DB 905.

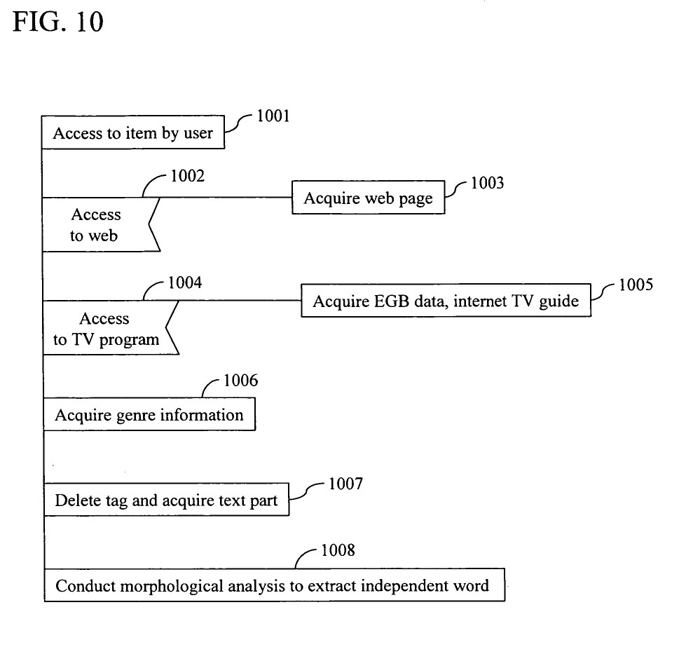

FIG. 10 shows the processes of the text information extraction function. Upon access to an item, such as Web browsing or TV viewing, by a user 1001, the system acquires a Web page 1003 when it is an access to a Web 1002, or acquires EPG data or an Internet TV Guide 1005 when it is an access to a TV program 1004.

Moreover, the system analyzes the presence or absence of tag information expressing the content, such as a genre or a category in a Web page, and attempts to acquire genre information of the information acquired in Processes 1003, 1005 (1006). The system removes the tags of the information acquired in Processes 1003, 1005 to acquire a text part 1007, and carries out morphological analysis to the acquired text data to extract an independent word 1008.

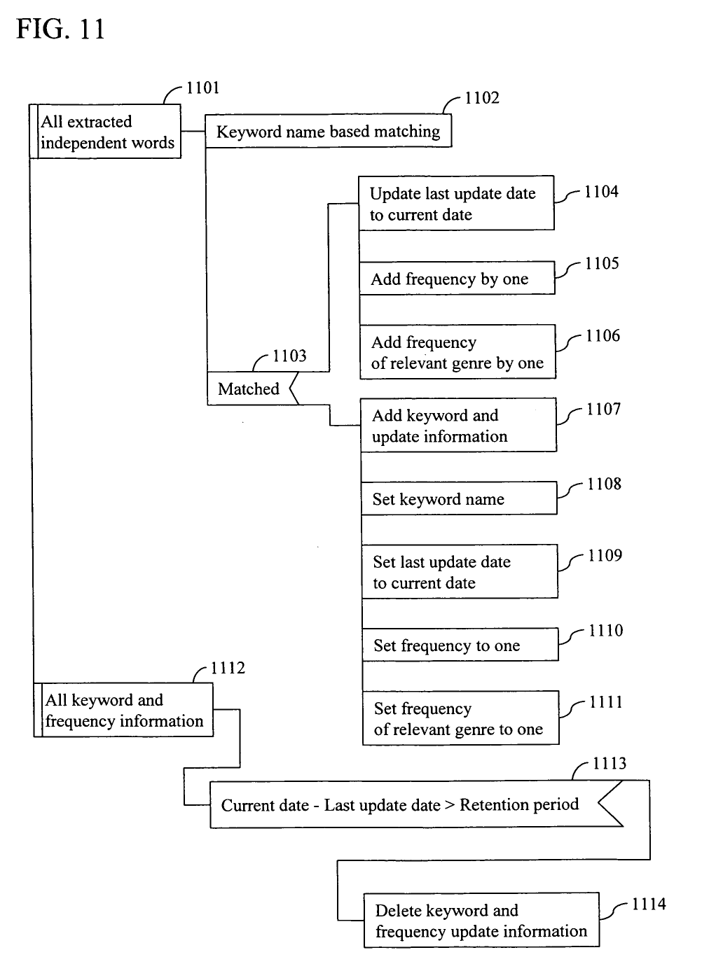

FIG. 11 shows the processes of the keyword record DB update function. With respect to all the extracted independent words 1101, matching is performed with a keyword name in the keyword record DB shown in FIG. 4 1102, and if a matching keyword exists (1103), then the last update date in the keyword record DB of FIG. 4 is changed to the current date 1104, and the frequency is added by one 1105, and if the genre information is already acquired, then the frequency of the genre is added by one 1106. If a matching keyword does not exist (1103), then the keyword and update information is added in the keyword record DB of FIG. 4 (1107), the keyword name is set 1108, the last update date is set to the current date 1109, and the frequency is set to one 1110. If the genre information is already acquired, then the frequency of the relevant genre is set to one 1111. Note that in order to secure the system performance (processing speed and storage capacity), a keyword that has not appeared for a predetermined period is deleted in Processes 1112 to 1114.

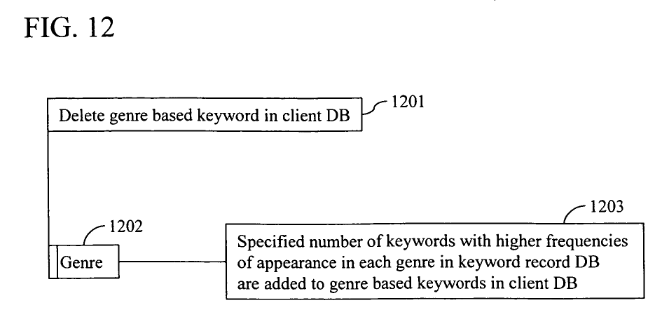

FIG. 12 shows the processes of the client DB update function. In the client DB update function, first, a genre based keyword in the client DB is deleted 1201, and a specified number of keywords with higher frequencies of appearance in each genre 1202 in the keyword record DB of FIG. 4 are added to the genre based keyword in the client DB 1203.

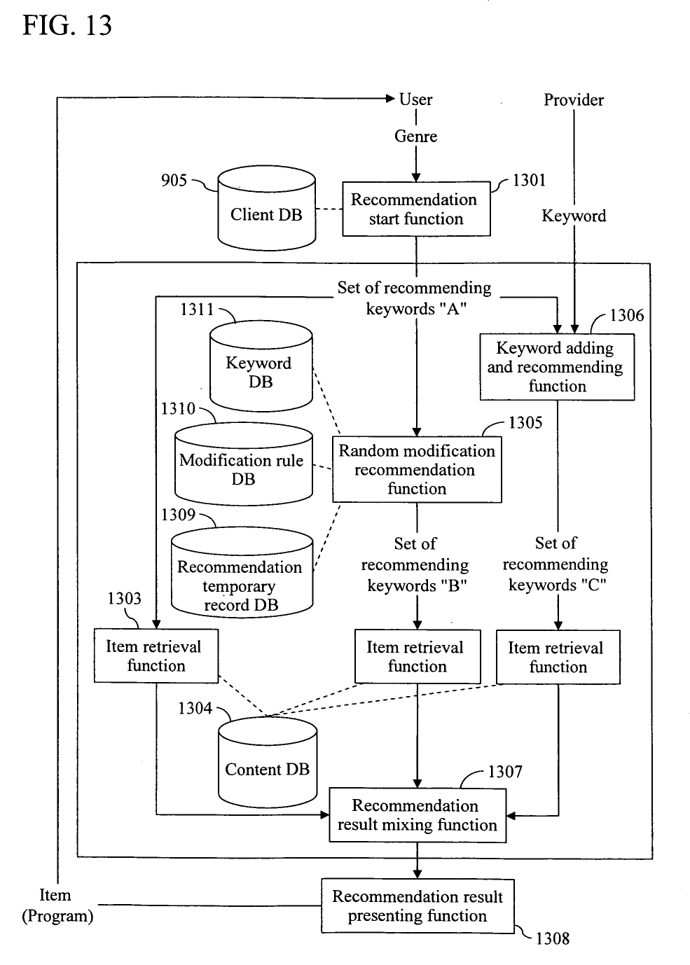

The mixing and recommending function is described using FIG. 13 to FIG. 16. Recommendation is started by depression of a recommendation button by a user (1301), and as described earlier, a set of preference keywords corresponding to a genre recorded in the client DB 905 is sent to the server. This set of preference keywords serves as a set of recommending keywords. This recommending keyword undergoes actions by random modification and keyword addition described below and is processed, and the resultant processed keyword is matched with the content DB 1304 to retrieve information about an item 1303. In the present invention, the recommendation results of content based recommendation, which is a conventional art, random modification recommendation (1305), and keyword adding recommendation (1306) are mixed together (1307), and this result is sent and presented to a client (1308).

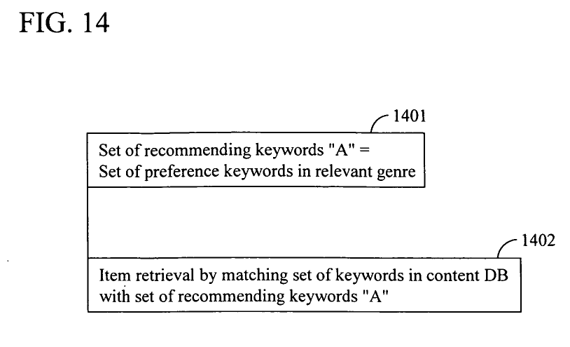

FIG. 14 shows the processes of the content based recommendation. In the conventional content based recommendation, a set of user preference keywords is used as the recommending keyword as it is. In other words, an item is recommended through the following processes: a set of recommending keywords A=a set of preference keywords in the relevant genre 1401, and information about an item is retrieved by matching a set of keywords in the content DB 1304 of FIG. 13 with the set of recommending keywords A 1402.

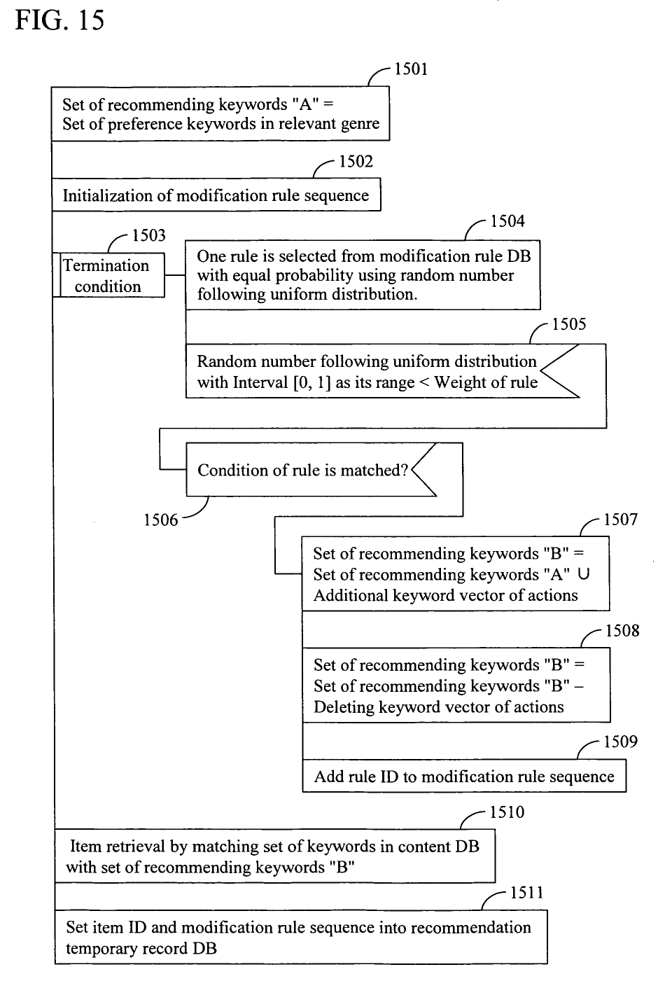

FIG. 15 shows the processes of the random modification recommendation. In the random modification recommendation, in order to create unexpectedness, with respect to a set of recommending keywords, a keyword which a user does not prefer is randomly added and a user preference keyword is randomly deleted, and the resultant one is used as the set of recommending keywords. The processing processes are as follows.

First, the set of recommending keywords A is set to a set of preference keywords in the relevant genre (1501). Here, for the purpose of later-described evaluation feedback, a modification rule sequence recorded in the recommendation temporary record DB 1309 of FIG. 13 is deleted and initialized (1502). Subsequently, a rule is randomly applied under a termination condition 1503 such as the number of times of repetition. In Process 1504, one rule is selected from the modification rule DB 1310 of FIG. 13 with equal probability using a random number following a uniform distribution. In Process 1505, if a random number following a uniform distribution with the interval [0, 1] as its range is smaller than the weight of the rule, the weight being indicative of the application frequency, this rule is adopted, or otherwise, the next rule is selected. This random selection method is called the biased coin method. If the condition of the adopted rule is matched (1506), namely the condition 804 in FIG. 8 coincides therewith, then this rule is applied, and a set of additional keywords 810 in the action 805 is added to the set of keywords (1507), and a set of deleting keywords 811 is deleted (1508). Moreover, the rule ID 80 of the applied rule is added to the rule ID to the modification rule sequence (1509). In this way, information about an item is retrieved by matching a set of keywords in the content DB 1304 of FIG. 13 with a set of processed recommending keywords (i.e., a set of recommending keywords B) (1510), and for the purpose of evaluation feedback, the item ID and modification rule sequence are set in the recommendation temporary record DB 1309 of FIG. 13 (1511).

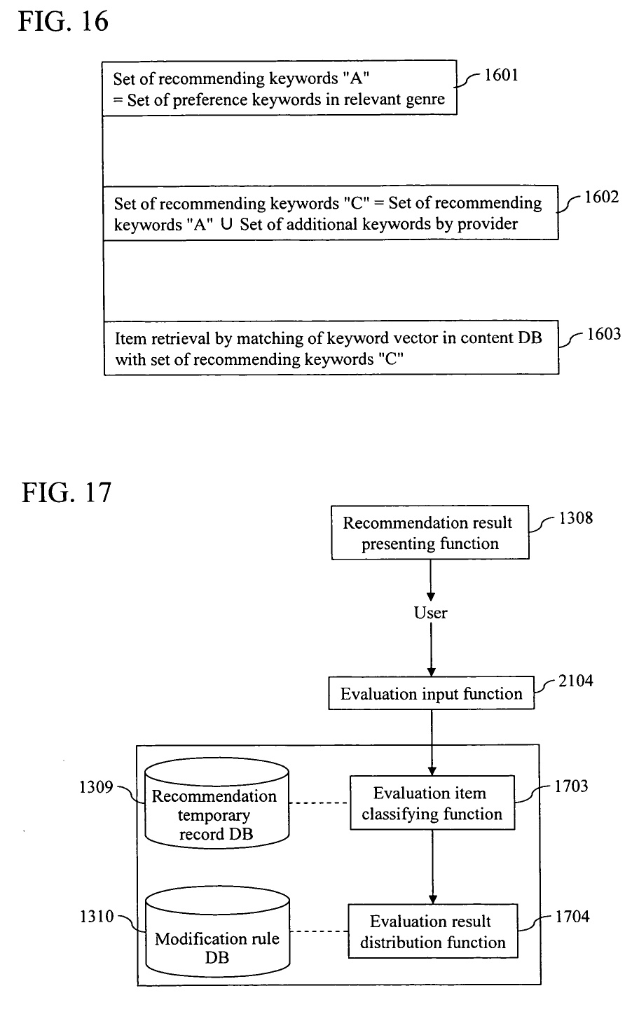

FIG. 16 shows the processes of the keyword adding recommendation. The keyword adding recommendation is a recommendation method for adding current news keywords, keywords related to a sponsor, topic keywords, and the like, in which a set of recommending keywords is set to a set of preference keywords in the relevant genre (1601), followed by addition of a set of additional keywords by a provider (1602). An item is then recommended during the process of item retrieval by matching a set of keywords in the content DB 1304 of FIG. 13 with a set of recommending keywords C 1603.

The mixing recommendation method includes three types of recommendation methods, i.e., content based recommendation, random modification recommendation, and keyword adding recommendation. Among these, the random modification recommendation method is for recommending an unexpected item.

On the other hand, the content based recommendation and the keyword adding recommendation are not for recommending an unexpected item but for preventing occurrence of a situation where presentation of only unexpected items results in no item which a user wishes to select. Thus, a user can select an item among both the expected items and unexpected items.

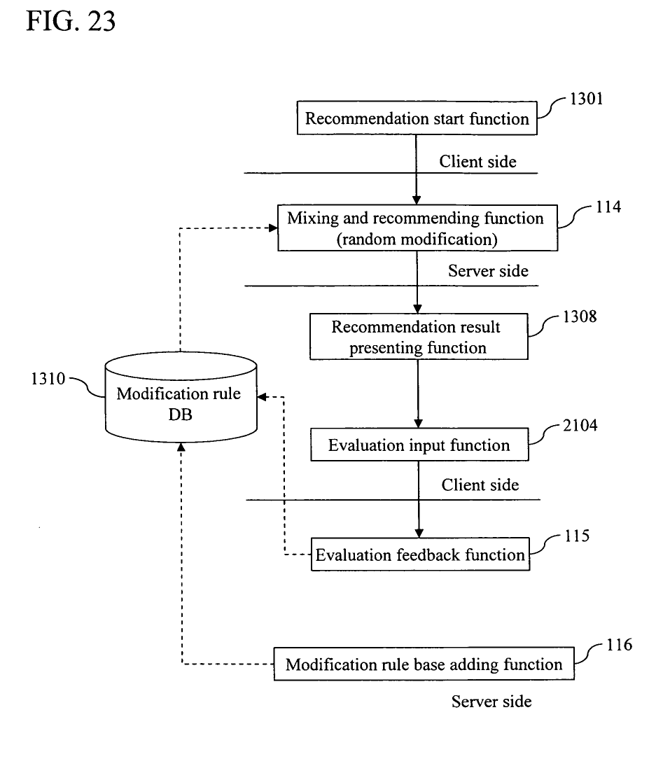

FIG. 23 shows a modification rule base repetitive learning process for efficiently recommending an unexpected item. Upon activation of the recommendation start function 1301 at the client side, the mixing and recommending function (random modification) is executed at the server side 114 and the recommendation result is sent to the client, and then the recommendation result presenting function 1308 is executed at the client side. When an evaluation of a user is sent to the server side via the evaluation input function 2104, in the evaluation feedback function 115 the weight given to a modification rule is learned as described later, whereby the weight of the existing modification rule is enhanced and an unnecessary modification rule is deleted. Furthermore, a new modification rule is added by the modification rule base adding function 116. The results of addition, deletion, weight change of the modification rule are reflected on the modification rule DB 1310 and used for next recommendation. By repeating these processes, the modification rule base learning is performed.

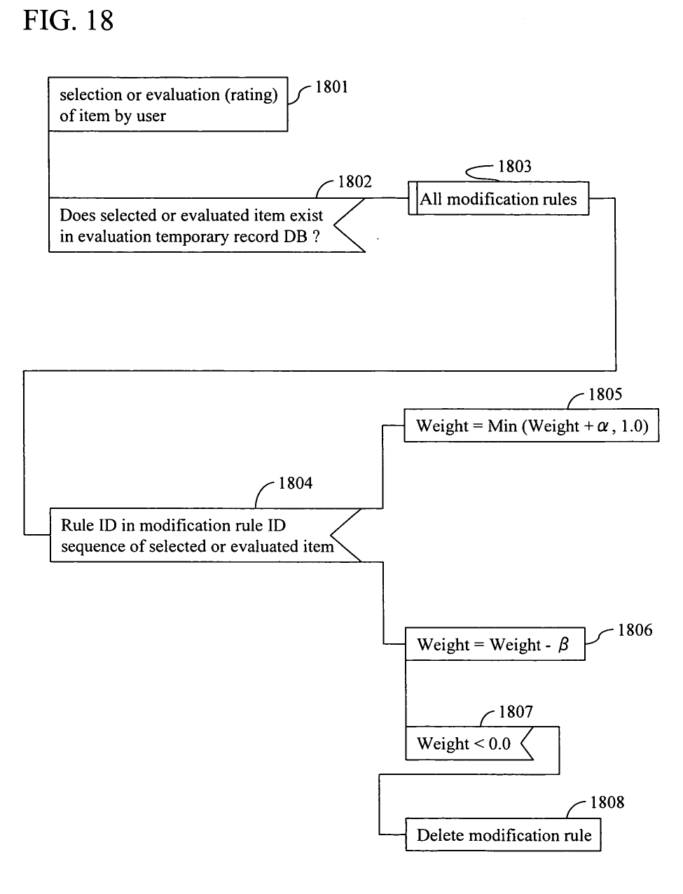

The evaluation feedback function is described using FIG. 17 and FIG. 18. FIG. 17 shows the evaluation feedback function. For the recommendation result of items by the recommendation result presenting function 1308, a user selects a part thereof or provides evaluation (rating) (2104). With reference to the recommendation temporary record DB 1309, whether or not a selected or evaluated item is a result of the random modification recommendation shown in FIG. 15 is determined and this item is classified (evaluation item classifying function 1703), and if it is a result of the random modification recommendation, the weight of a rule in the modification rule DB 1310 is updated by an evaluation result distribution function 1704.

FIG. 18 shows the processing processes thereof. When a user selects or evaluates (rated) an item 1801, and if the selected or evaluated item exists in the evaluation temporary record DB 1309 (1802), the weight is reset with respect to all the modification rules 1803 in the modification rule DB 1310. Among the modification rules, as for a rule in a modification rule ID sequence of the selected or evaluated item 1804, the weight thereof is updated with the following equation using a predetermined value a (1805).

Weight=min(weight+α,1.0) (1)

Otherwise, the weight is updated with the following equation using a predetermined value β (1806).

Weight=weight−β (2)

If this results in a negative weight (1807), the modification rule is deleted (1808).

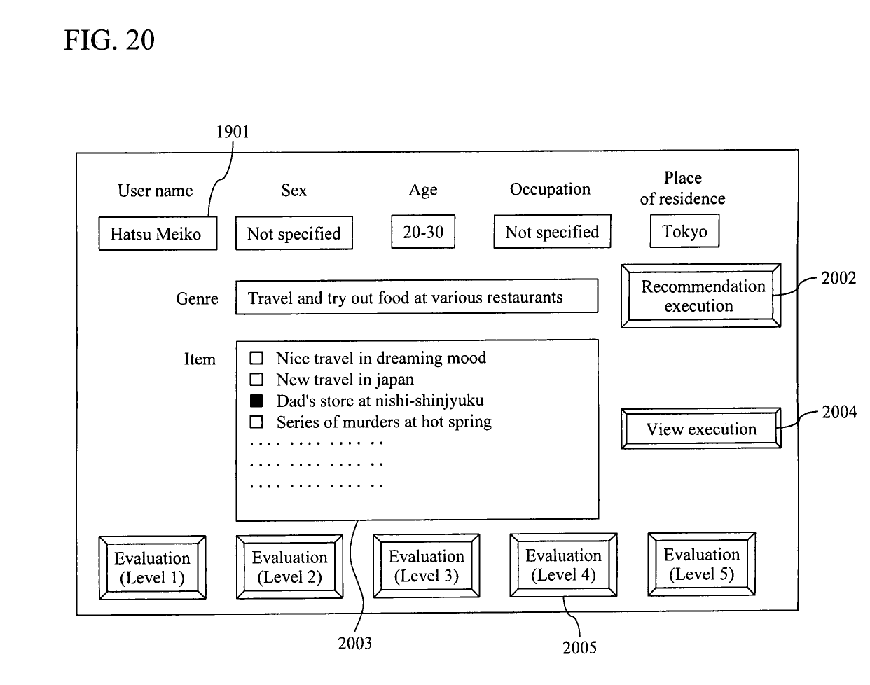

FIG. 20 shows a client interface. A small rectangular area 1901 is an area where information is displayed and edited. Upon depression of a recommendation execution button 2002, the system recommends items from the user name and genre, and displays the result in a list form (2003). When a list item is selected and a view execution button 2004 is depressed, the item is viewed, and when an evaluation button is depressed, an evaluation of the item is inputted 2005.

In the modification rule base learning process of FIG. 23, a modification rule is added by the modification rule base adding function 116. In adding a modification rule, two approaches are used in combination. One approach is a case where the system randomly sets the genre 807, sex 812, age 813, occupation 814, place of residence 815, and keywords 816 to 820 of FIG. 8 at predetermined time intervals to add a modification rule to the modification rule DB. A modification rule applied with this approach has a drawback in that the degree to which the modification rule is applied is small, i.e., an item that is recommended to a user by using this modification rule will be seldom selected by a user or be seldom highly evaluated. However, because the modification rule DB 1310 of FIG. 22 is shared by all the users, a modification rule used in an item that was selected by a certain user once may be most likely to be reused by other users. On the contrary, a modification rule that is less often applied will be deleted from the modification rule DB 1310 by the function of deleting a modification rule 1808 of FIG. 18.

The other approach to add a modification rule is a case where a provider manually prepares the rule 801 of FIG. 8 using the modification rule adding support function 2209 of FIG. 22 with reference to an EPG of a new item (TV program) or an Internet TV Guide. For example, when terms “hot spring” and “detective” exist in an EPG or an Internet TV Guide of “Murder at a Hot Spring”, “hot spring” is set as a keyword of the condition 809 and “detective” is set as a keyword of the additional keyword 810, so that an item (TV program) which is unlikely to be recommended only with “hot spring” can be recommended.

Hereinafter, an example of the support method for constructing a modification rule base by a provider is described. With respect to a new item (TV program), keywords in a related text data are extracted with reference to an EPG or an Internet TV Guide, and a pair of these keywords is generated. Since the number of the pairs of keywords is a square of the number of keywords and is numerous, a predetermined number of keywords are randomly generated. As for the generated pairs of keywords, the information is presented to a user as follows.

A keyword pair of generated keyword A and keyword B is expressed as (A, B). With regard to all the users, the user preference keywords 313, 314 in the client DB of FIG. 3 are checked to calculate the frequencies of appearance of the keyword A and keyword B, and these values are set to α and β, respectively. Moreover, with regard to all the items, the sets of keywords 506, 507 in the content DB of FIG. 5 are checked to calculate the frequency of appearance of the keyword pair (A, B), and this value is set to γ. If the value of α is high (as compared with a predetermined value) and the value of β is low (as compared with a predetermined value) and the value of γ is low (as compared with a predetermined value), then the candidate “if A then add (B)” is generated for a modification rule to be added, and the keyword pair (A, B) is presented to a user. The phrase “the value of α is high” means that the keyword A is a user preference keyword for a lot of users, the phrase “the value of γ is low” means that the keyword B is an unexpected keyword for a lot of users, and the phrase “the value of 0 is low” means that the keyword pair (A, B) is inherent to the item. Thus, an item containing the unexpected keyword B can be recommended to a lot of users whose preference keyword is the keyword A.

Moreover, with regard to all the items, not only a modification rule for adding a keyword is added, but also a modification rule for deleting a keyword is added as follows. That is, the sets of keywords 506, 507 in the content DB of FIG. 5 are checked to randomly generate a keyword pair (A, C) as described above, and then the frequency of appearance thereof is calculated, and this value is expressed as χ. With regard to all the users, the sets of user preference keywords 313, 314 in the content DB of FIG. 3 are checked to randomly generate the keyword pair (A, C) as described above, and then the frequency of appearance thereof is calculated and this value is expressed as γ. When the value of γ is high (as compared with a predetermined value), the keyword pair (A, C) is presented to a user in order to generate the candidate “if A then delete (C)” for a modification rule to be deleted. By preventing recommendation of an item that is characterized by the quite frequently appearing keyword pair (A, C), the likelihood of recommendation of the item characterized by the keyword B is increased.

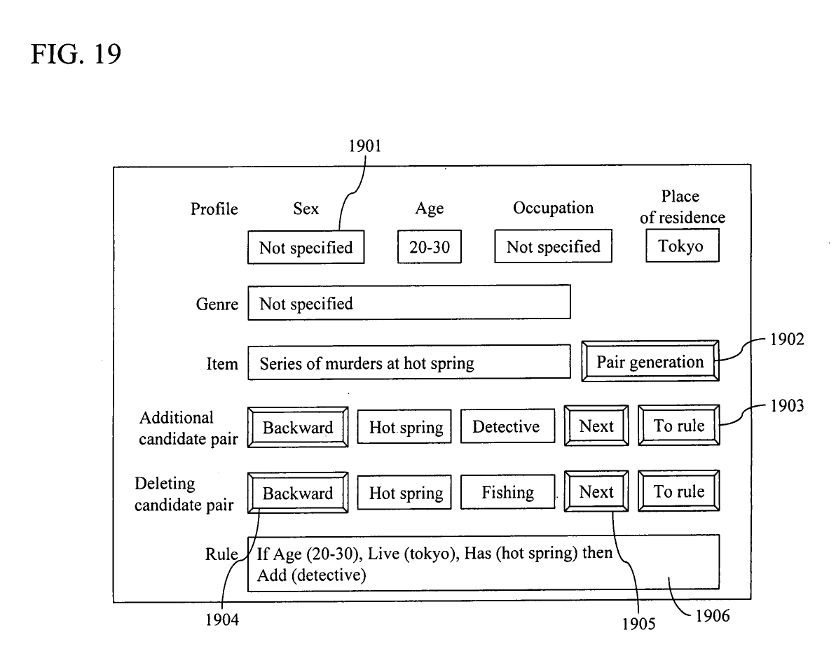

FIG. 19 shows a modification rule base adding support interface in the modification rule adding support function 2209 of FIG. 22. A small rectangular area 1901 is an area where information is displayed and edited. A pair generation button 1902 is a button for analyzing an item, generating a keyword pair, performing filtering, and presenting the result as described earlier. The result is displayed as an additional candidate or a deleting candidate, and is reflected on the rule by depression of a button 1903. Moreover, other additional candidate pair or other deleting candidate pair is displayed by depressing a backward button 1904 or a next button 1905, and the rule is displayed in an area 1906.

The present invention can be used for recommendation of a program or a scene in a broadcast or television system, for recommendation of a product in online shopping, and for product promotion in marketing.

According to the present invention, an item highly unexpected to a user can be recommended with high efficiencies.

What is claimed is:

1. An item recommendation system, comprising:
a client including:
a keyword extracting unit that extracts keywords related to an accessed or selected item;
a recording unit that stores information about a user, and keywords with high frequency of appearance among the extracted keywords; and
an input and output unit,
the client sending a plurality of keywords stored in the recording unit; and
a server including:
a content database that associates an item with keywords indicative of a content of the item, and stores information about the association;
a modification rule database that stores a plurality of rules for changing a part of keywords in a keyword group;
a retrieval keyword preparing unit that randomly applies one of the rules stored in the modification rule database to a plurality of keywords received from the client, so as to prepare a retrieving keyword group;
a retrieval unit that retrieves information from the content database by using the retrieving keyword group; and
a sending unit that sends, to the client, information about an item, the information being retrieved by the retrieval unit by using the retrieving keyword group prepared by the retrieval keyword preparing unit.

2. The item recommendation system according to claim 1, wherein the rules include a rule for adding a set of predetermined keywords to the plurality of keywords received from the client.

3. The item recommendation system according to claim 1, wherein the rules include a rule for removing a part of keywords from the plurality of keywords received from the client.

4. The item recommendation system according to claim 1, wherein each rule includes a condition about a user, and can be applied when the condition is satisfied by the information about the user, the information being received from the client.

5. The item recommendation system according to claim 1, wherein each rule includes a condition about a keyword, and can be applied when the plurality of keywords received from the client include a keyword specified by the condition.

6. The item recommendation system according to claim 1, wherein each rule is given a weight indicative of to what degree the rule can be applied to a keyword.

7. The item recommendation system according to claim 1, wherein the server has a function to change the weight on the basis of at least one of item selection and item evaluation by the client.

8. The item recommendation system according to claim 1, wherein
information about an item, which information is retrieved by the retrieval unit using a retrieving keyword group prepared by the retrieval keyword preparing unit, is mixed with information about an item, which information is retrieved by the retrieval unit using, as a retrieving keyword group, the plurality of keywords received from the client, and
information on the result of the mixture is sent to the client from the sending unit.

9. The item recommendation system according to claim 1, wherein
information about an item, which information is retrieved by the retrieval unit using a retrieving keyword group prepared by the retrieval keyword preparing unit; information about an item, which information is retrieved by the retrieval unit using, as a retrieving keyword group, the plurality of keywords received from the client; and information about an item, which information is retrieved by the retrieval unit using, as a retrieving keyword group, keywords obtained by adding a predetermined keyword to the plurality of keywords received from the client, are mixed together, and
information on the result of the mixture is sent from the sending unit to the client.
